(19) United States
(12) Patent Application Publication
(10) Pub. No.: US 2026/0015206 A1
(43) Pub. Date: Jan. 15, 2026

(54) METHOD AND APPARATUS FOR DETECTING THE STATE OF A PLURALITY OF LAYER DOOR SWITCHES

(71) Applicant: Otis Elevator Company, Farmington, CT (US)

(72) Inventors: Heping Qiu, Shanghai (CN); Hongliang Tian, Shanghai (CN)

(21) Appl. No.: 19/262,908

(22) Filed: Jul. 8, 2025

(30) Foreign Application Priority Data
Jul. 11, 2024 (CN) 202410928736.9

(51) Int. Cl. B66B 13/22

(52) U.S. Cl. CPC B66B 13/22

(57) ABSTRACT

A method and device for detecting states of a plurality of landing door switches, an elevator system. The plurality of landing door switches are divided into m switch groups. The device for detecting the states of the plurality of landing door switches includes m signal input lines and n signal output lines. Each signal input line is connected with a first end or input end of each landing door switch within one of the m switch groups, and each signal output line is connected with a second end or output end of one of the landing door switches within each of the m switch groups. A controller is connected with the m signal input lines and the n signal output lines, and is configured to apply a detection signal onto the ith signal input line and determine the state of each landing door switch.

### FOREIGN PRIORITY

This application claims priority to Chinese Patent Application No. 202410928736.9, filed Jul. 11, 2024, and all the benefits accruing therefrom under 35 U.S.C. § 119, the contents of which in its entirety are herein incorporated by reference.

### TECHNICAL FIELD OF INVENTION

The present disclosure relates to elevator technology and, in particular, to a method and device for detecting states of a plurality of landing door switches, an elevator system comprising the device, a non-transitory computer-readable storage medium for implementing the method, and a computer program product.

### BACKGROUND OF THE INVENTION

An elevator system typically includes a plurality of door interlocking devices, each mounted on a corresponding landing door. The elevator system also includes landing door switches for detecting locked and unlocked states of the door interlocking devices. These landing door switches are connected in series with each other to form a landing door safety chain. During elevator operation, an operating signal indicative of the on-off state of the landing door safety chain is sent to an elevator control device to enable the elevator control device to operate an elevator car correctly.

When the safety chain is broken due to the failure of one of the landing door switches, the elevator system comes to an emergency stop and trapped person inside the car waits for rescue. Passengers will be trapped in the car for a long time as it takes more time to locate the faulty landing door switch and troubleshoot the problem.

### SUMMARY OF THE INVENTION

In accordance with an aspect of the present disclosure, there is provided a method and device for detecting states of a plurality of landing door switches, an elevator system comprising the device, a non-transitory computer-readable storage medium for implementing the method, and a computer program product.

In accordance with an aspect of the present disclosure, there is provided a device for detecting states of a plurality of landing door switches. In some embodiments, the plurality of landing door switches are divided into m (m≥2) switch groups. The device includes m signal input lines and n (n≥2) signal output lines. Each signal input line is connected with a first end or input end of each landing door switch within one of the m switch groups, and each signal output line is connected with a second end or output end of one of the landing door switches within each of the m switch groups. In the above-described device, a controller is connected with the m signal input lines and the n signal output lines, and is configured to apply a detection signal onto the ith signal input line and determine the state of each landing door switch of the switch group connected with the ith signal input line based on a response signal on a respective one of the n signal output lines.

Optionally, in the above-described device, the controller applies the detection signal onto the m signal input lines in sequence to detect the state of each landing door switch.

Optionally, in the above-described device, the detection signal is a pulse signal.

Optionally, in the above-described device, the controller comprises I/O channels connected with the m signal input lines and n transmission lines for applying the detection signal and reading the response signal on the n signal output lines. Further optionally, the controller also comprises a SPI input channel connected with a landing door state detection module or a safety input module.

In addition to comprising one or more of the above features, the above-described device is a Programmable Electronic System in Safety Related Applications for Lifts (PESSRAL).

In accordance with another aspect of the present disclosure, there is provided an elevator system. The elevator system comprises a car, landing door switches divided into m (m≥2) switch groups, and a control unit. In the above-described elevator system, the control unit includes m signal input lines and n (n≥2) signal output lines. Each signal input line is connected with a first end or input end of each landing door switch within one of the m switch groups, and each signal output line is connected with a second end or output end of one of the landing door switches within each of the m switch groups. In the above-described control unit, a controller is connected with the m signal input lines and the n signal output lines, and is configured to apply a detection signal onto the ith signal input line and determine the state of each landing door switch of the switch group connected with the ith signal input line based on a response signal on a respective one of the n signal output lines.

In accordance with another aspect of the present disclosure, there is provided a method for detecting states of a plurality of landing door switches. In some embodiments, the plurality of landing door switches are divided into m (m≥2) switch groups, each of m signal input lines is connected with a first end of each landing door switch within one of the m switch groups, and each of n (n≥2) signal output lines is connected with a second end of one of the landing door switches within each of the m switch groups. In the above-described method, a detection signal is applied onto the m signal input lines in sequence, and for the ith signal input line, the state of each landing door switch of the switch group connected with the ith signal input line is determined based on a response signal on a respective one of the n signal output lines.

In accordance with a further aspect of the present disclosure, there is provided a non-transitory computer-readable storage medium having stored thereon a computer program/instruction that implements the steps of the method as described above when the computer program/instruction is executed by a processor.

In accordance with a still further aspect of the present disclosure, there is provided a computer program product comprising a computer program/instruction that implements the steps of the method as described above when the computer program/instruction is executed by a processor.

### BRIEF DESCRIPTION OF THE DRAWINGS

The above and/or other aspects and advantages of the present disclosure will be clearer and more easily understood from the following description of various aspects in conjunction with the accompanying drawings, in which the same or similar units are denoted by the same reference numerals. The accompanying drawings include:

FIG. 1 is a view of an exemplary elevator system.

FIG. 2 is a schematic block diagram of a device for detecting states of a plurality of landing door switches in accordance with an embodiment of the present disclosure.

FIG. 3 is a schematic diagram of an array of nodes in accordance with another embodiment of the present disclosure.

FIG. 4 is a schematic diagram of an array of nodes in accordance with another embodiment of the present disclosure.

FIG. 5 is a schematic block diagram of an elevator system in accordance with an embodiment of the present disclosure.

FIG. 6 is a flowchart of a method for detecting states of a plurality of landing door switches in accordance with another embodiment of the present disclosure.

FIG. 7 is a schematic block diagram of a control device.

### DETAILED DESCRIPTION OF THE INVENTION

The present disclosure is described more fully below with reference to the accompanying drawings, in which illustrative embodiments of the present disclosure are illustrated. However, the present disclosure may be implemented in different forms and should not be construed as limited to the embodiments presented herein. The presented embodiments are intended to make the disclosure herein comprehensive and complete, so as to more comprehensively convey the protection scope of the present disclosure to those skilled in the art.

In this specification, terms such as “comprising” and “including” mean that in addition to units and steps that are directly and clearly stated in the specification and claims, the technical solution of the present disclosure does not exclude the presence of other units and steps that are not directly or clearly stated in the specification and claims.

In this specification, a landing station usually refers to a location on each floor that are used for the entry and exit of passenger objects (e.g., passengers, machinery and equipment, etc.) to and from the car.

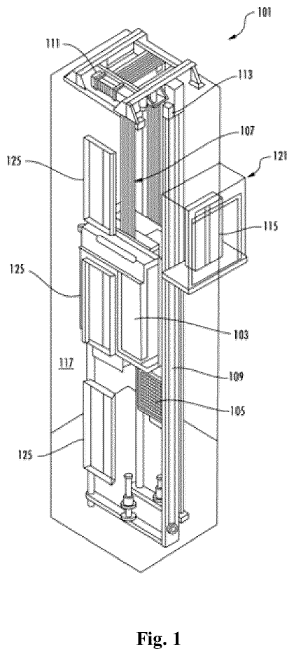

FIG. 1 is a view of an exemplary elevator system. An elevator system 101 shown in FIG. 1 includes an elevator car 103, a counterweight 105, a tensioning component 107, a guide rail (or rail system) 109, a unit (or unit system) 111, a position reference system 113, and an electronic elevator controller (controller) 115. The elevator car 103 and the counterweight 105 may be connected to each other via the tensioning component 107. The tensioning component 107 may include or be configured as, for example, a rope, a steel cable, and/or a coated steel strip. The counterweight 105 is configured to balance a load of the elevator car 103 and is configured to assist in moving the elevator car 103 within an elevator shaft (or shaft) 117 and along the guide rail 109 in opposite directions relative to the counterweight 105 simultaneously.

The tensioning component 107 may engage the unit 111, the unit 111 may be part of a header structure of the elevator system 101. The unit 111 is configured to control movement between the elevator car 103 and the counterweight 105. The position reference system 113 may be mounted on a fixed portion at the top of the elevator shaft 117, such as on a support member or guide rail, and may be configured to provide a position signal related to the position of the elevator car 103 within the elevator shaft 117. In other embodiments, the position reference system 113 may be mounted directly to a moving assembly of the unit 111, or may be located in other locations and/or configurations as known in the art. The position reference system 113 may be any device or mechanism for monitoring the position of the elevator car and/or the counterweight as is known in the art. As may be appreciated by those skilled in the art, the position reference system 113 includes, for example, but is not limited to, an encoder, a sensor, or other systems, and may implement various sensing such as velocity sensing, absolute position sensing, and the like.

As shown, the controller 115 is located in a controller compartment 121 of the elevator shaft 117 and is configured to control operation of the elevator system 101 (and in particular, the elevator car 103). For example, the controller 115 may provide a drive signal to the unit 111 to control acceleration, deceleration, leveling, stopping, and the like of the elevator car 103. The controller 115 may also be configured to receive the position signal from the position reference system 113 or any other desired position reference device. While moving up or down along the guide rail 109 within the elevator shaft 117, the elevator car 103 may stop at one or more landing stations 125 as controlled by the controller 115. Although shown in the controller compartment 121, those skilled in the art will appreciate that the controller 115 may be located and/or configured at other places or locations within the elevator system 101. In an embodiment, the controller may be remotely located or located in a cloud.

The unit 111 may include a motor or similar drive mechanism. According to embodiments of the present disclosure, the unit 111 is configured to include an electrically driven motor. A power source for the motor may be any power source, including a power grid, the power source being supplied to the motor in combination with other components. The unit 111 may include a traction pulley, the traction pulley transmitting force to the tensioning component 107 to move the elevator car 103 within the elevator shaft 117.

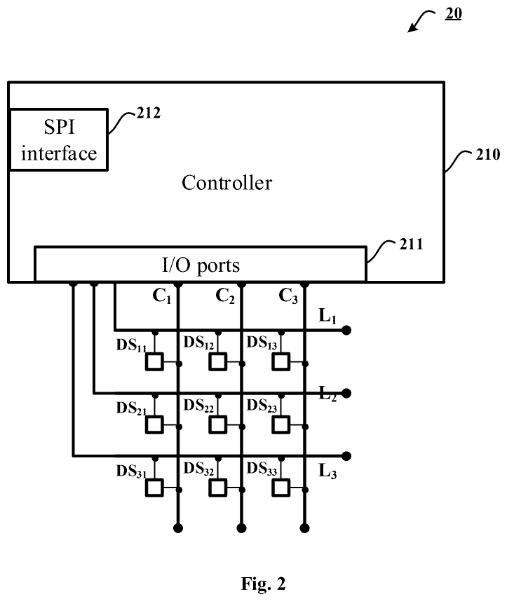

FIG. 2 is a schematic block diagram of a device for detecting states of a plurality of landing door switches in accordance with an embodiment of the present disclosure. Exemplarily, a device 20 shown in FIG. 2 is implemented utilizing a Programmable Electronic System in Safety Related Applications for Lifts (PESSRAL). The PESSRAL system is an electronic system that integrates conventional elevator control functions with safety functions such as elevator safety monitoring and protection, and may comprise a single controller, or a plurality of controllers that operate in concert to implement various conventional control functions and safety functions. Integration can improve operational efficiency, reduce device space occupation, and lower development and manufacturing costs. However, those skilled in the art will recognize, after reading the following specific description, that the described function of detecting the states of the landing door switches may also be implemented in other ways, such as using a safety controller independent of an elevator controller to perform the function of detecting.

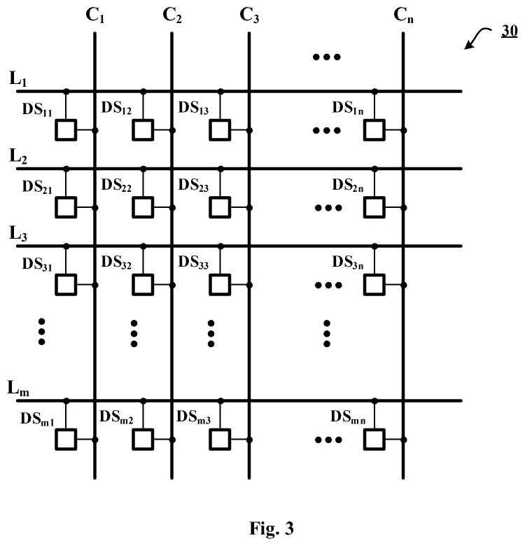

Unlike the approach of connecting all the landing door switches in series to form a safety chain, in this embodiment, the landing door switches may be organized in the form of an array of nodes, wherein each landing door switch corresponds to one of the nodes of the array of nodes. In the following description, the terms “landing door switch” and “node” are used interchangeably unless otherwise specified. Taking the case in which the m×n landing door switches are equally divided into m switch groups as an example, FIG. 3 illustrates a schematic diagram of an array of nodes corresponding to the case. Referring to FIG. 3, an array of nodes 30 contains m signal input lines L1 to Lm that are not connected to each other, n signal output lines C1 to Cn, and a plurality of nodes located near intersections of the signal input lines and the signal output lines. Taking the jth landing door switch DSij within the ith switch group as an example, it is located near the intersection of the ith signal input line Li and the jth signal output line Cj, and its input end and output end are connected with the ith signal input line Li and the jth signal output line Cj, respectively. As a result, each row of the array of nodes corresponds to one of the switch groups, and each column of the array of nodes corresponds to a column comprising a landing door switch having the same serial number j within each switch group.

In this embodiment, each landing door switch is connected between a corresponding signal input line and a signal output line in accordance with an array form similar to that shown in FIG. 3. By applying a detection signal onto only one of the plurality of signal input lines at a time and simultaneously detecting a response signal on each of the signal output lines, it is possible to determine a state (e.g., a closed state and an open state) of each of the landing door switches within the switch group corresponding to the signal input line to which the detection signal is applied. Exemplarily, a signal level on the signal output line may characterize the response signal.

It should be noted that the number of landing door switches does not ensure that they satisfy the condition of being equally divided into a plurality of switch groups, and thus the number of landing door switches within each switch group may or may not be consistent. Taking the elevator system containing 12 landing door switches as an example, these landing door switches may be divided into 4 groups, each containing 3 landing door switches. Taking the elevator system containing 19 landing door switches as an example, these landing door switches may be divided into 5 groups, with each of the first 4 groups containing 4 landing door switches, and the last group containing 3 landing door switches. In short, various divisions may be used to group the landing door switches.

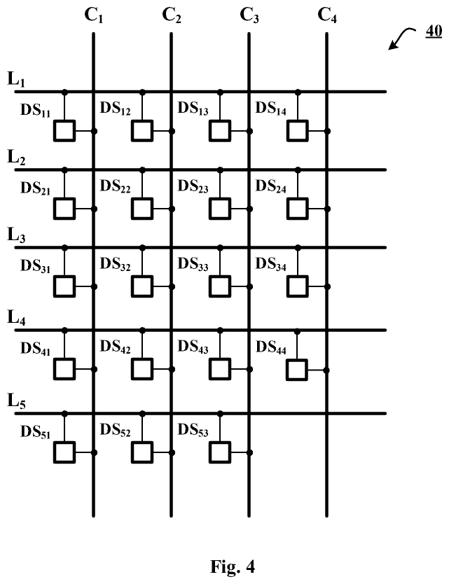

It should also be noted that in the case where the number of landing door switches within each switch group is not the same, it is also possible to connect the landing door switches with the signal input lines and the model output lines in accordance with the form of an array of nodes similar to that shown in FIG. 3, in order to realize an individual determination of the state of each landing door switch. Taking the elevator system containing 19 landing door switches as an example, these landing door switches may, for example, be connected with the signal input lines and the model output lines in accordance with the form of an array of nodes 40 shown in FIG. 4. As will be recognized upon reading the present disclosure, the inability of the landing door switches to be equally divided into switch groups does not pose an obstacle to the implementation of the function of detecting the states of the landing door switches described herein.

Continuing to refer to FIG. 2, the device 20 shown includes three signal input lines L1 to L3, three signal output lines C1 to C3, and a controller 210. Taking the elevator system containing 9 landing door switches equally divided into three switch groups G1 to G3 as an example, the signal input lines L1 to L3 are connected with an input end of each landing door switch within one of the switch groups G1 to G3 respectively, for example, the signal input line L1 is connected with the input ends of the landing door switches DS11 to DS13 within the switch group G1, the signal input line L2 is connected with the input ends of the landing door switches DS21 to DS23 within the switch group G2, and the signal input line L3 is connected with the input ends of the landing door switches DS31 to DS33 within the switch group G3; on the other hand, the signal output lines C1 to C3 are connected with an output end of one of the landing door switches within each of the switch groups G1 to G3, for example, the signal output line C1 is connected with the output ends of the landing door switches DS11, DS21, and DS31, the signal output line C2 is connected with the output ends of the landing door switches DS12, DS22, and DS32, and the signal output line C3 is connected with the output ends of the landing door switches DS13, DS23, and DS33.

In some examples, the controller 210 may, for example, be a microcontroller integrating elevator control functions and safety functions. In other examples, the controller 210 may, for example, also be a microcontroller dedicated to implementing the safety functions. As shown in FIG. 2, the controller 210 comprises a group of I/O ports or I/O channels 211 connected with the signal input lines and the signal output line. During the execution of the function of detecting, the controller 210 applies a detection signal S onto one of the signal input lines L1 to L3 via the corresponding I/O port, and reads a response signal S′ of the signal output lines C1 to C3 via the corresponding I/O port. If the response signal S′ has similar characteristics (for example, including but not limited to one or more of the following: signal amplitude, signal waveform, spectral component and half-peak width, etc.) to the detection signal S, then it is determined that the corresponding landing door switch is in a closed state, otherwise, it is determined that it is in an open state. To determine the state of the landing door switch DS23, for example, the controller 210 may apply a detection signal S onto the signal input line L2 and read a response signal S′ on the signal output line C3. In some examples, the controller 210 may determine the state of each landing door switch by applying the detection signal S in sequence onto the signal input lines L1 to L3 and reading the response signal of the signal output lines C1 to C3.

Various signals may be used as the detection signals in this embodiment, such as including, but not limited to, pulse signals, constant level signals, and pulse width modulated signals. The use of pulse signals as the detection signals helps to accurately detect the response signals even in strong noise environments, and thus avoids the use of cable wires with strong electromagnetic shielding capabilities as the signal input wires and signal output wires.

Referring to FIG. 2, the controller 210 also comprises an SPI input channel or SPI interface 212. The controller 210 may communicate with safety-related electronic modules (e.g., a landing door state detection module, etc.) on a SPI bus via the SPI interface 212 to obtain landing door state information sensed by landing door state sensors (e.g., door magnetic switches and infrared sensors, etc.). Since mutually independent I/O channels and SPI input channels are utilized to provide the landing door state information, the reliability of the execution of the safety function is improved.

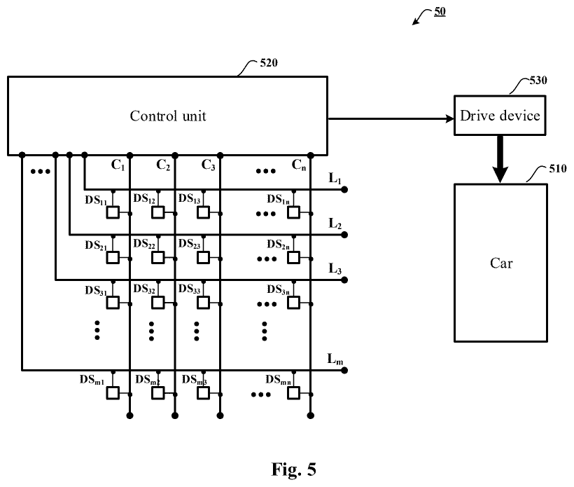

FIG. 5 is a schematic block diagram of an elevator system in accordance with an embodiment of the present disclosure. As shown in FIG. 5, an elevator system 50 includes a car 510, a control unit 520 (which may be, for example, the device 20 shown in FIG. 2), a drive device 530 (which includes, for example, the unit 111 of FIG. 1), and a plurality of landing door switches DS11 to DSmn.

Exemplarily, the landing door switches DS11 to DSm×n are equally divided into m switch groups and form an array of nodes in accordance with the manner shown in FIG. 3. Referring to FIG. 5, m signal input lines L1 to Lm and n signal output lines C1 to Cn are connected with a controller (e.g., the controller 210 of FIG. 2) of the control unit 520. In some examples, the controller may determine the state of each landing door switch by applying the detection signal S in sequence onto the signal input lines L1 to Lm and reading the response signal on the signal output lines C1 to Cn. The application of the detection signal and the reading of the response signal as described above may be performed periodically to realize real-time monitoring of the states of the landing door switches.

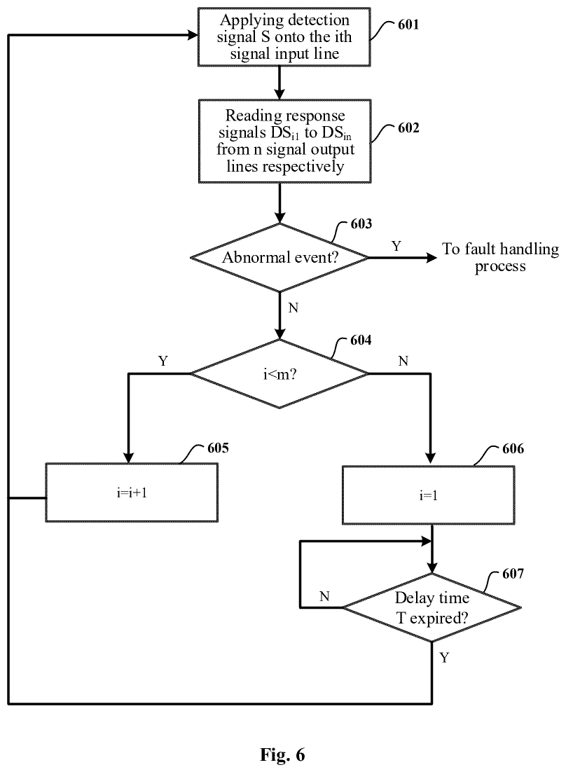

FIG. 6 is a flowchart of a method for detecting states of a plurality of landing door switches in accordance with another embodiment of the present disclosure. The method described below may be implemented by various devices, which include, for example, but are not limited to, controllers in an elevator system (e.g., the controller 115 in FIG. 1 and the controller 210 in FIG. 2), etc., which will be collectively referred to hereinafter as control devices. In this embodiment, similar to the previous embodiments, the landing door switches are divided into a plurality of switch groups and form an array of nodes in accordance with the manner shown in FIG. 3 or 4.

The method shown in FIG. 6 begins at step 601, in which the control device applies a detection signal S (e.g., a pulse signal, a constant level signal, or a pulse width modulated signal, etc.) onto the ith signal input line. In the operation cycle comprising steps 601 to 605, i takes the value of 1 when step 601 is first performed.

Subsequently, proceeding to step 602, the control device reads the response signals S′i1 to S′in of the landing door switches DSi1 to DSin from n signal output lines respectively to determine the states of these landing door switches.

Next, in step 603, the control device determines whether an abnormal event occurs based on the states of the landing door switches DSi1 to DSin. If it occurs, it proceeds to a fault handling process, otherwise, it proceeds to step 604.

In the case of normal operation of the elevator system, after the car stops at the destination floor or the landing door, the door interlocking device of the landing door will change from the locked state to the unlocked state, at which time the landing door will be opened and the corresponding landing door switch will enter the open state. On the other hand, a malfunction of the elevator system may also cause the door interlocking device to enter the unlocked state (at which time the landing door is open), and accordingly, the landing door switch is also in the open state. This non actively controlled unlocking will put passengers in great danger, especially when the car is in motion or the car is in a non-stop position. In some examples, the open of the landing door switch as a result of the door interlocking device entering the unlocked state without active control is considered an abnormal event or a fault event. In the fault handling process, the control device will perform a fault handling operation in response to the occurrence of this abnormal event, such as stopping the movement of the car 510 by controlling the drive device 530 and reporting the fault to a cloud or remote server.

In step 604, the control device will determine whether the application of the detection signal S has traversed the m signal input lines or whether the m signal input lines have been sequentially applied with the detection signal S. If the condition is satisfied, proceed to step 605, otherwise, proceed to step 606. In some examples, a counter may be set to count the number of times i that the detection signal has been applied, whereby determination may be made based on a comparison result of the current count value and the m. For example, if the current count value i<m, it is determined that all signal input lines have not been traversed.

In step 605, the control device will increment the serial number of the signal input line to which the detection signal S is to be applied next or the count value of the counter, i.e., i=i+1.

After step 605, the flow shown in FIG. 6 returns to step 601. In this step, the control device continues to apply the detection signal S onto the remaining signal input lines in sequence.

In another branch step 606 of step 604, the control device will reset the serial number of the signal input line to which the detection signal S is to be applied next or the count value of the counter to 1.

Subsequently, entering step 607, the control device determines whether a set delay time T is experienced, and if it is true, returns to step 601 to restart a new operation cycle comprising steps 601 to 605, otherwise, continues to wait. By setting this delay time T, the execution period of the state detection operation of the plurality of landing door switches can be adjusted.

It is to be noted that when the functions such as the abnormal event monitoring are assigned to an independent safety controller, the fault handling process has a different execution body from the steps 601 to 607, i.e., the steps 601 to 607 may be executed by the safety controller, whereas the fault handling process may be executed using an elevator controller responsible for the conventional functions of the elevator (e.g., the controller 115 in FIG. 1). Conversely, when functions such as abnormal event monitoring, elevator system control, and abnormal event reporting are integrated within a single control unit, the fault handling process and steps 601 to 607 may have the same execution body.

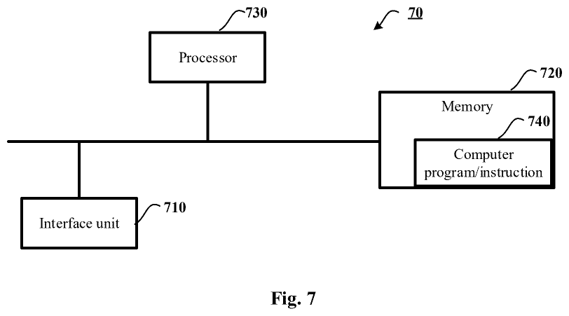

FIG. 7 is a schematic block diagram of a control device. A control device shown in FIG. 7 may be used, for example, to implement controllers in an elevator system (e.g., the controller 115 in FIG. 1 and the controller 210 in FIG. 2).

As shown in FIG. 7, the control device 70 comprises an interface unit 710, one or more memories 720 (e.g., non-volatile memories such as flash memory, ROM, hard disk drives, magnetic disks, optical disks, etc.), one or more processor cores 730, and computer program/instruction 740.

The interface unit 710 may, for example, include a group of I/O ports and an SPI interface configured to receive commands and signals (e.g., the aforementioned response signals) from external devices (e.g., other units of the elevator system (e.g., the unit 111, the position reference system 113 in FIG. 1, and the signal output lines C1 to C3 in FIG. 2), etc.) or networks (e.g., the Internet and a wireless LAN, etc.) as well as send commands and signals (e.g., the aforementioned detection signals) generated at the control device 70 to the external devices (such as signal input lines L1 to L3 in FIG. 2) or networks.

The memory 720 stores the computer program/instruction 740 that may be executed by the processor core 730. In addition, the memory 720 may also store data generated by the processor core 730 in executing the computer program/instruction 740 and data (e.g., movement speed and position of the car and response signals, etc.) received from external devices via the interface unit 710.

The processor core 730 is configured to run the computer program/instruction 740 stored on the memory 720 and perform access operations to the memory 720.

The computer program/instruction 740 may include computer instruction code for implementing various functions and operations described with the aid of FIGS. 2 to 6, enabling the functions and operations of these to be implemented by running the computer program/instruction 740 on the processor core 730.

Those skilled in the art will appreciate that various illustrative logical blocks, modules, circuits, and algorithm steps described herein may be implemented as electronic hardware, computer software, or combinations of both.

To demonstrate this interchangeability between the hardware and software, various illustrative components, blocks, modules, circuits, and steps have been described above generally in terms of their functionality. Whether such functionality is implemented in hardware or software depends on the particular application and design constraints imposed on the overall system. Those skilled in the art may implement the described functionality in changing ways for the particular application. However, such implementation decisions should not be interpreted as causing a departure from the scope of the present disclosure.

Although only a few of the specific embodiments of the present disclosure have been described, those skilled in the art will appreciate that the present disclosure may be embodied in many other forms without departing from the spirit and scope thereof. Accordingly, the examples and implementations shown are to be regarded as illustrative and not restrictive, and various modifications and substitutions may be covered by the present disclosure without departing from the spirit and scope of the present disclosure as defined by the appended claims.

The embodiments and examples presented herein are provided to best illustrate embodiments in accordance with the present technology and its particular application, and to thereby enable those skilled in the art to implement and use the present disclosure. However, those skilled in the art will appreciate that the above description and examples are provided for convenience of illustration and example only. The presented description is not intended to cover every aspect of the present disclosure or to limit the present disclosure to the precise form disclosed.

What is claimed is:

1. A device for detecting states of a plurality of landing door switches, wherein the plurality of landing door switches are divided into m (m≥2) switch groups, the device comprising:
m signal input lines, each signal input line being connected with a first end of each landing door switch within one of the m switch groups;
n (n≥2) signal output lines, each signal output line being connected with a second end of one of the landing door switches within each of the m switch groups; and
a controller connected with the m signal input lines and the n signal output lines, configured to perform the following operation: apply a detection signal onto the ith signal input line, and determine the state of each landing door switch of the switch group connected with the ith signal input line based on a response signal on a respective one of the n signal output lines.

2. The device of claim 1, wherein the controller is configured to apply the detection signal onto the m signal input lines in sequence.

3. The device of claim 1, wherein the detection signal is a pulse signal.

4. The device of claim 1, wherein the controller comprises I/O channels connected with the m signal input lines and n transmission lines for applying the detection signal and reading the response signal on the n signal output lines.

5. The device of claim 4, wherein the controller also comprises a SPI input channel connected with a landing door state detection module or a safety input module.

6. The device of claim 4, wherein the device is a Programmable Electronic System in Safety Related Applications for Lifts (PESSRAL).

7. An elevator system comprising:
a car;
a plurality of landing door switches divided into m (m≥2) switch groups; and
a control unit comprising:
m signal input lines, each signal input line being connected with a first end of each landing door switch within one of the m switch groups;
n (n≥2) signal output lines, each signal output line being connected with a second end of one of the landing door switches within each of the m switch groups; and
a controller connected with the m signal input lines and the n signal output lines, configured to perform the following operation: apply a detection signal onto the ith signal input line, and determine the state of each landing door switch of the switch group connected with the ith signal input line based on a response signal on a respective one of the n signal output lines.

8. The elevator system of claim 7, wherein the controller is configured to apply the detection signal onto the m signal input lines in sequence.

9. The elevator system of claim 7, wherein the detection signal is a pulse signal.

10. The elevator system of claim 7, wherein the controller comprises I/O channels connected with the m signal input lines and n transmission lines for applying the detection signal and reading the response signal on the n signal output lines.

11. The elevator system of claim 10, wherein the controller also comprises a SPI input channel connected with a landing door state detection module or a safety input module.

12. The elevator system of claim 10, wherein the control unit is a Programmable Electronic System in Safety Related Applications for Lifts (PESSRAL).

13. A method for detecting states of a plurality of landing door switches, wherein the plurality of landing door switches are divided into m (m≥2) switch groups, each of m signal input lines is connected with a first end of each landing door switch within one of the m switch groups, and each of n (n≥2) signal output lines is connected with a second end of one of the landing door switches within each of the m switch groups, the method comprising:
applying a detection signal onto the m signal input lines in sequence; and
for the ith signal input line, determining the state of each landing door switch of the switch group connected with the ith signal input line based on a response signal on a respective one of the n signal output lines.

14. The method of claim 13, wherein the detection signal is a pulse signal.

15. A non-transitory computer-readable storage medium having stored thereon a computer program/instruction that implements the steps of the method as claimed in claim 13 when the computer program/instruction is executed by a processor.
